(19) United States
(12) Patent Application Publication
(10) Pub. No.: US 2026/0218886 A1
(43) Pub. Date: Jul. 30, 2026

(54) DETACHABLE LAMP HEAD STRUCTURE AND LIGHTING FIXTURE

(71) Applicants: FUJIAN YDJ LIGHT CO., LTD, Fuzhou (CN); Jolux lighting LLC, Sheridan, WY (US)

(72) Inventors: Lili Guan, Fuzhou (CN); Kaijian Lai, Fuzhou (CN)

(21) Appl. No.: 19/437,275

(22) Filed: Dec. 30, 2025

(30) Foreign Application Priority Data
Jan. 27, 2025 (CN) 202520175770.3

(51) Int. Cl. F21V 19/00; F21V 19/02; F21V 23/00; F21V 23/06

(52) U.S. Cl. CPC F21V 19/0035; F21V 19/02; F21V 23/007; F21V 23/06

(57) ABSTRACT

Provided are a detachable lamp head structure and a lighting fixture. A bottom end of the threaded lamp head is connected to a top end of the structural column, and a bottom end of the structural column is detachably connected to a top of the connection panel. A center of the connection panel is provided with an opening, and its bottom is connected to a rear of the electrical unit. A power end of the driver is electrically connected to a conductive end of the threaded lamp head through a conductive wire, and the driver is electrically connected to the electrical unit, achieving an electrical connection between the electrical unit and a threaded lamp socket as well as a basic electrical function of the electrical unit. Through a detachable connection between the connection panel and the structural column, it is convenient to separate the LED light panel separately.

### CROSS-REFERENCE TO RELATED APPLICATIONS

This application claims priority to Chinese Patent Application No. 202520175770.3, filed on January 27, 2025, which is hereby incorporated by reference in its entirety.

### TECHNICAL FIELD

The present disclosure relates to the field of lighting fixture technologies, and in particular, to a detachable lamp head structure and a lighting fixture.

### BACKGROUND

Threaded lamps used to match threaded lamp sockets usually use ordinary light bulbs (such as incandescent lamps), and existing LED lamps have higher energy efficiency, that is, the illuminance generated per unit of energy is higher. In contrast, ordinary light bulbs convert more energy into heat rather than light energy, resulting in lower energy efficiency.

Therefore, existing lighting fixtures often use LED lights instead of ordinary light bulbs in threaded lights. LED lights can be configured as a light plate structure, occupying less space. The LED light plate is connected to the threaded lamp sockets through a threaded lamp head component to achieve power supply and lighting. The common threaded lamp head component has a bottom end that is integrated with the LED light panel and cannot be disassembled, resulting in a larger packaging volume and higher packaging costs during transportation.

Therefore, it is necessary to provide a detachable lamp head structure and a lighting fixture to solve problems of a bottom end of the common threaded lamp head component being integrated with a LED light panel, which cannot be disassembled, and the packaging volume is large, and the packaging cost is high during transportation.

To achieve the above objectives, the present disclosure provides a detachable lamp head structure, including: a threaded lamp head, a structural column, a connection panel, an electrical unit, and a driver;

a bottom end of the threaded lamp head is connected to a top end of the structural column, and a bottom end of the structural column is detachably connected to a top of the connection panel, a center of the connection panel is provided with an opening, and its bottom is connected to a rear of the electrical unit; the driver is provided inside the structural column, the connection panel, or outside the structural column and the connection panel; a power end of the driver is electrically connected to a conductive end of the threaded lamp head through a conductive wire, and the driver is electrically connected to the electrical unit.

In some embodiments of the present disclosure, a detachable connection method between the connection panel and the structural column includes threaded rotation connection, snap fit connection, slider groove connection, and pin connection; and/or

the threaded lamp head includes a plurality of screw heads with different specifications.

In some embodiments of the present disclosure, a sleeve ring is provided on the connection panel, and the sleeve ring is configured to mutually sleeve connect with a bottom end of the structural column.

In some embodiments of the present disclosure, it further includes a limit convex ring;

where the limit convex ring is provided on an outer side of a bottom of the structural column, and there is a distance between a bottom of the limit convex ring and a bottom end of the structural column, or the limit convex ring is provided on a lower edge of an inner side of the sleeve ring.

In some embodiments of the present disclosure, the structural column is a telescopic structure, the telescopic structure includes a plurality of telescopic sleeves, adjacent two telescopic sleeves are interlocked and an end of the telescopic sleeves is provided with a fixing component, and the fixing component is configured to limit a maximum distance of mutual sliding between the two telescopic sleeves.

In some embodiments of the present disclosure, it further includes conductive components, and the conductive components are respectively provided on the connection panel and the structural column; when the connection panel is connected to the structural column, the conductive components of the connection panel are electrically connected to the conductive components of the structural column.

In some embodiments of the present disclosure, it further includes a box, where the box is provided between the structural column and the connection panel, and the driver is provided inside the box.

In some embodiments of the present disclosure, an upper side of the box is open, and covered by connecting with the connection panel, and a bottom of the box is provided with a plurality of through holes.

The present disclosure provides a lighting fixture, including an LED light panel and a lamp head structure. The lamp head structure is any one of the lamp head structures described in the embodiments of the present disclosure, where the LED light panel serves as the electrical unit of the lamp head structure and is electrically connected to the driver of the lamp head structure, and the LED light panel is detachably connected to the connection panel of the lamp head structure.

In some embodiments of the present disclosure, it further includes a color temperature toggle switch, and the color temperature toggle switch is provided on the structural column or connection panel of the lamp head structure, and is electrically connected to the driver; where the driver is configured to change a color temperature of the LED light panel according to a state of the color temperature toggle switch.

Different from existing technologies, the bottom end of the threaded lamp head in the above technical solution is connected to the top end of the structural column, and the bottom end of the structural column is detachably connected to the top of the connection panel. The center of the connection panel is provided with an opening, and its bottom is connected to the rear of the electrical unit. The power end of the driver is electrically connected to the conductive end of the threaded lamp head through a conductive wire, and the driver is electrically connected to the electrical unit, thereby achieving an electrical connection between the lamp and the threaded lamp head as well as a basic electricity demand function of the lamp. Through the detachable connection between the connection panel and the structural column, it can be disassembled for transportation, with a smaller packaging volume and reduced costs.

### BRIEF DESCRIPTION OF DRAWINGS

FIG. 1 is a structural perspective view of a detachable lamp of the present disclosure.

FIG. 2 is a structural perspective view of a detachable connection method of the detachable lamp of the present disclosure.

FIG. 3 is a structural perspective view of another detachable connection method of the detachable lamp of the present disclosure.

FIG. 4 is a perspective view of a structure column of the present disclosure, which is a telescopic structure.

FIG. 5 is a structural perspective view of the detachable lamp of the present disclosure with conductive components.

FIG. 6 is a front structural view of the detachable lamp of the present disclosure with a spring buckle.

FIG. 7 is a structural perspective view of the detachable lamp of the present disclosure with a box.

FIG. 8 is a structural perspective view of another embodiment of the detachable lamp of the present disclosure.

FIG. 9 is a structural perspective view of the detachable lamp of the present disclosure with a color temperature toggle switch.

Numeral reference: 10- threaded lamp head; 20- structural column; 30- connection panel; 301 -opening; 302- sleeve ring; 40- LED light panel; 50- driver; 60- limit convex ring; 61- spring buckle; 62- conductive component; 70- lampshade; 80- box.

### DESCRIPTION OF EMBODIMENTS

To provide a detailed explanation of the technical content, structural features, achieved goals, and effects of the technical solution, the following will be explained in combination with specific implementation modes and accompanying drawings.

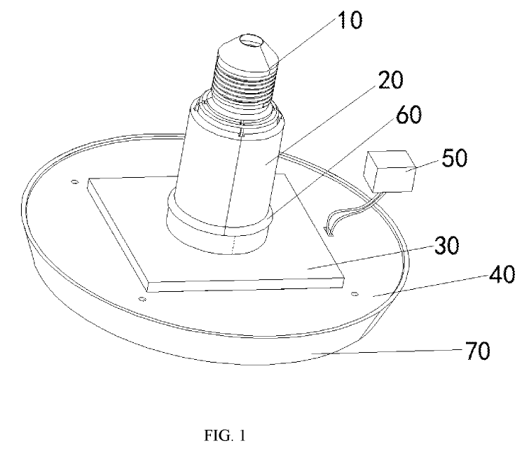

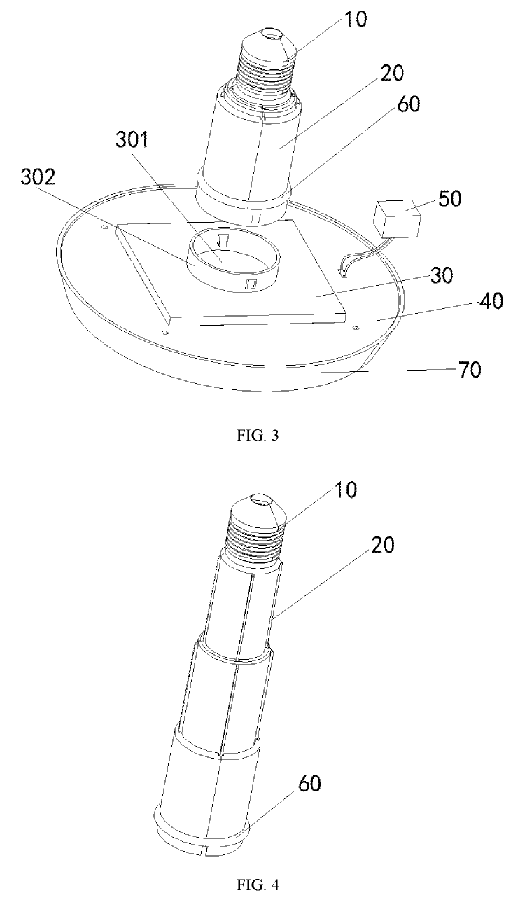

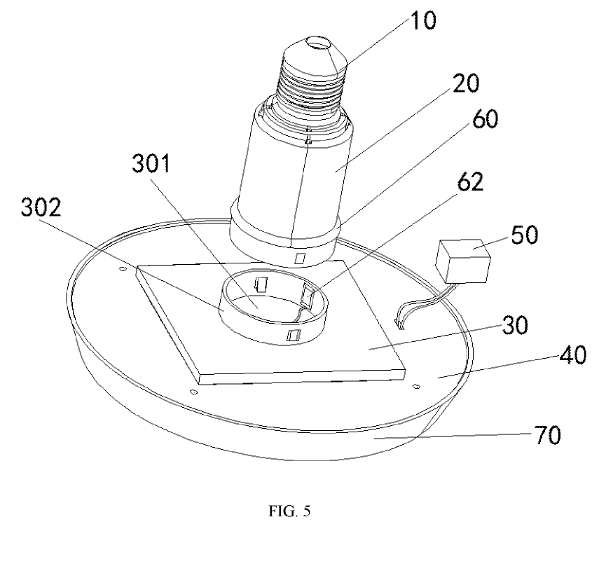

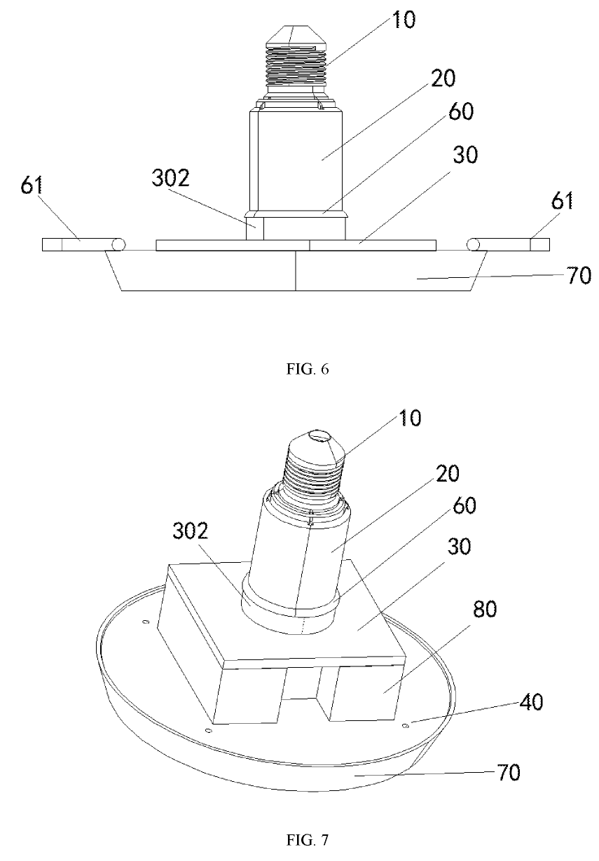

Please refer to FIGS. 1 to 9. The present disclosure provides a detachable lamp head structure and a lighting fixture, including a threaded lamp head 10, a structural column 20, a connection panel 30, an electrical unit, and a driver 50. The electrical unit of the present disclosure can be an LED light panel 40 or other electrical units such as a Bluetooth ^{TM} speaker, a camera, a router, or a spotlight. The driver 50 is configured to convert mains power into voltage and Direct Current, (DC) power required by the electrical unit. This embodiment will be described using the LED light panel 40. Other electrical units can refer to setup instructions for the LED light panel 40. A bottom end of the threaded lamp head 10 is connected to a top end of the structural column 20, and a bottom end of the structural column 20 is detachably connected to a top of the connection panel 30. A center of the connection panel 30 is provided with an opening 301, and its bottom is connected to a rear of the LED light panel 40. One side where LED beads of the LED light panel 40 are located is facing downwards. A power end of the driver 50 is electrically connected to a conductive end of the threaded lamp head 10 through a conductive wire, and the driver 50 is electrically connected to the LED light panel 40.

The structural column 20 is a hollow cylindrical structure with a length that is compatible with the threaded lamp head. The structural column 20 is configured to connect the threaded lamp head 10 and the connection panel 30, thereby forming a certain distance between the connection panel 30 and the threaded lamp head 10. The LED light panel 40 is connected below the connection panel 30. Based on a length of the threaded lamp head, a sufficiently long structural column 20 can be used to easily grasp a bottom end of the structural column 20 by hand, the top of the structural column 20 is inserted into the threaded lamp head, and manually rotate it to electrically connect the threaded lamp head 10 with the threaded lamp head. In an implementation mode, the structural column 20 can be configured as a telescopic structure, which can be a multi section pipe that are connected together by threads or sockets, and can be adjusted in length by rotation or stretching, such as telescopic canes and telescopic lamp posts. In an implementation mode, the telescopic structure includes a plurality of telescopic sleeves, with adjacent telescopic sleeves interlocked and a fixing component at an end of the telescopic sleeves. The fixing component is configured to limit a maximum distance of mutual sliding between the two telescopic sleeves. The telescopic sleeves and the fixing component can refer to a multi-stage adjustable telescopic lamp previously proposed by the applicant, and disclosed in CN217928515U, which will not be repeated here. By configuring the structural column 20 as the telescopic structure, an overall functionality of the lamp can be adjusted within a certain range of conditions, thereby achieving a certain range of length expansion and contraction. It can be matched with threaded lamp heads 10 with various specifications and is suitable for threaded lamp heads with different specifications, thereby improving practicality and convenience.

The threaded lamp head 10 is configured for threaded electrical connection with a threaded lamp socket. The threaded lamp heads 10 with different specifications can be adapted according to the threaded lamp sockets with different specifications. The threaded lamp head 10 includes a plurality of screw heads with different specifications, such as an E27 threaded lamp head 10 with a diameter of 27 millimeters; an E14 type threaded lamp head 10 with a diameter of 14 millimeters; an E12 type threaded lamp head 10 with a diameter 12 millimeters; an E40 type threaded lamp head 10 with a diameter of 40mm; a G9 type threaded lamp head 10 with a pin spacing of 9 millimeters; and a GU10 threaded lamp head 10 with a pin spacing of 10 millimeters.

The driver 50 is configured to control LED beads of the LED light panel 40 to emit light. In an implementation mode, the driver 50 is an LED controller, which drives the LED to emit light by rectifying and transforming the mains power. It is also possible to achieve remote switching, dimming intensity, color temperature adjustment, etc. of the LED light panel 40 by using the driver 50, which extends the life of the LED light panel 40, saves power consumption, and is easy to connect and use. At the same time, it can achieve lighting changes such as jumping and gradient according to needs.

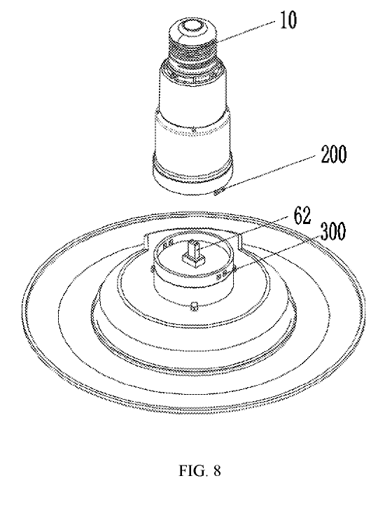

A detachable connection method between the connection panel 30 and the structural column 20 includes threaded rotation connection, snap fit connection, slider groove connection, and pin connection. The following is an example of the detachable connection method: 1. threaded rotation connection: the threaded rotation connection between the connection panel 30 and the structural column 20 is achieved by providing internal and external threads at corresponding positions of the connection panel 30 and the structural column 20, and then rotating the connection panel 30 and the structural column 20 to achieve the connection. An installation process is to align the connection panel 30 and the structural column 20, and then rotate the connection panel 30 and the structural column 20 until the internal and external threads are threaded and tightened. A dismantling process involves rotating the connection panel 30 and structural column 20 in reverse until they are completely separated. 2. Snap fit connection: the snap fit connection between the connection panel 30 and the structural column 20 is achieved by providing a buckle 200 and a clamp groove 300 at corresponding positions of the connection panel 30 and the structural column 20 (as shown in FIG. 8), aligning the connection panel 30 and the structural column 20, and inserting the buckle into the clamp groove by applying downward force to achieve the connection. The installation process involves aligning the connection panel 30 with the structural column 20, and then applying force to insert the buckle into the clamp groove. The disassembly process involves applying force to remove the buckle from the clamp groove, and then separating the connection panel 30 from the structural column 20. 3. Slider groove connection: the slider groove connection between the connection panel 30 and the structural column 20 is achieved by providing a slider and a sliding groove at corresponding positions of the connection panel 30 and the structural column 20, aligning the connection panel 30 and the structural column 20, and inserting the slider into the sliding groove by applying downward force. The installation process involves aligning the connection panel 30 with the structural column 20, and then applying force to insert the slider into the sliding groove. The disassembly process involves applying force to remove the slider from the sliding groove, and then separating the connection panel 30 from the structural column 20. 4. pin connection: the pin connection between the connection panel 30 and the structural column 20 is achieved by proving pins and sockets at corresponding positions of the connection panel 30 and the structural column 20, aligning the connection panel 30 and the structural column 20, and inserting the pins into the sockets to achieve the connection. The installation process involves aligning the connection panel 30 with the structural column 20, and then inserting the plug into the socket. The disassembly process involves applying force to remove the plug from the socket, and then separating the connection panel 30 from the structural column 20.

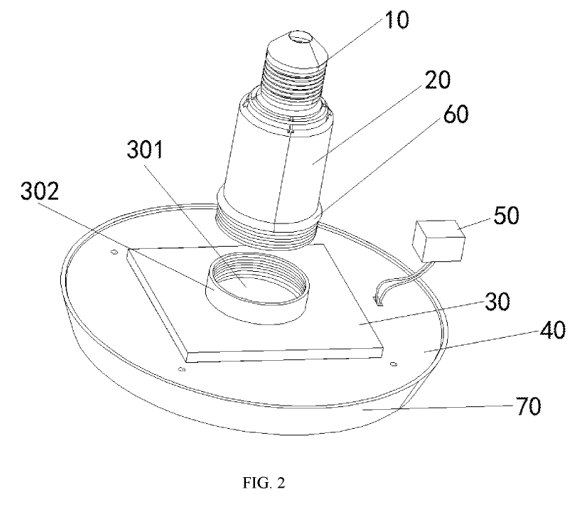

In an implementation mode, taking the attached figure as an example for further explanation, referring to FIGS. 1 and 2, a sleeve ring 302 is provided at an outer edge of the opening 301 on the connection panel 30. A size of the sleeve ring 302 is adapted to a circular opening of a lower end of the structural column 20. That is, when the connection panel 30 is connected to the structural column 20, a bottom end of the structural column 20 is embedded into an inner side of the sleeve ring 302, or the sleeve ring 302 is embedded into a bottom end of an inner side of the structural column 20, thereby achieving a rapid sleeve connection between the connection panel 30 and the structural column 20. When disassembly is required, only force needs to be applied to separate the two. This connection method is simple to operate and more convenient for connection or disassembly. In order to improve the stability of the connection, an elastic ring can also be provided on a contact surface between the sleeve ring 302 and the structural column 20. Through a deformation elastic recovery force of the elastic ring, pressure can be applied to the sleeve ring 302 and the structural column 20, thereby improving the stability of the connection.

When the structural column 20 is sleeved onto the inner side of the sleeve ring 302, the structural column 20 may be excessively inserted downwards, reducing the overall length and possibly pressing against the LED light panel 40, causing malfunction. Therefore, in order to avoid an excessive insertion of the structural column 20 downwards, a limit convex ring 60 is further included, and the limit convex ring 60 is provided on an outer side of a bottom of the structural column 20 and has a distance between the bottom of the limit convex ring 60 and the bottom end of the structural column 20, or the limit convex ring 60 is provided at a lower edge of the inner side of the sleeve ring 302. When the structural column 20 is sleeved into the inner side of the sleeve ring 302, the limit convex ring 60 provided on an outer side of the bottom of the structural column 20 will contact the sleeve ring 302, thereby restricting the structural column 20 from continuing to move downward. Or the limit convex ring 60 provided on a lower edge of the inner side of the sleeve ring 302 will contact a bottom end of the structural ring, thereby restricting the structural column 20 from continuing to move downward.

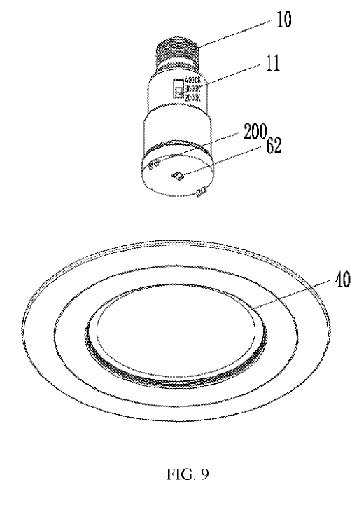

In the aforementioned embodiments, the electrical connection between the LED light panel 40 and the threaded lamp head 10 can all be achieved through wire connection. That is, one end of the wire is electrically connected to a grounding end of the LED light panel 40, and the other end first passes through the opening 301 in a center of the connection panel 30, and then extends upward to the threaded lamp head 10 inside the structural column 20 for electrical connection. It should be noted that when the structural column 20 is a telescopic structure, a length of the wire should not be shorter than a distance between the LED light panel 40 and the threaded lamp head 10 in an extended state, thereby achieving electrical connection. However, in practical applications, this electrical connection method further includes conductive components 62, which are respectively provided on the connection panel 30 and the structural column 20. When the connection panel 30 is connected to the structural column, the conductive components 62 of the connection panel 30 are electrically connected to the conductive components 62 of the structural column 20. As shown in FIGS. 8 and 9, the conductive component 62 can be a pair of plugs and sockets to achieve insertion and electrical connection.

In an implementation mode, there are also spring buckles 61, which have at least two spring buckles 61. A plurality of spring buckles 61 are symmetrically provided around a center of the LED light panel 40, with the spring buckles 61 provided at the edge of the LED light panel 40. The light fixture can be quickly fixed on a ceiling by using the spring buckle 61.

In an implementation mode, there is also a lampshade 70 connected to a bottom of the LED light panel 40. The lampshade 70 can provide protection to prevent the LED beads on the LED light panel 40 from being damaged by impact, and can also prevent dust and water damage. By adjusting material of the lampshade 70, different lighting effects can be achieved.

In the aforementioned embodiments, the driver 50 only needs to be electrically connected to the LED light panel 40. The driver 50 itself can be exposed to the outside, especially when the lamp is provided on the ceiling. The structure above the lampshade 70 is located inside the ceiling, and the driver 50 is not easily damaged when exposed. However, in some usage scenarios, the lamp is not provided on the ceiling, and there is a risk of damage to the driver 50 when the driver 50 is exposed. In order to protect the driver 50, in an implementation mode, a box 80 is further included, the box 80 is provided between the structural column and the connection panel 30. The driver 50 is placed inside the box 80, and the box 80 can be provided with a box cover, which has a side opening. The driver 50 can be installed in and covered to achieve protecting the driver 50. In an implementation mode, the upper opening 301 of the box 80 is connected to the connection panel 30 for closure, and a bottom of the box 80 is provided with a plurality of through holes. An area of the connection panel 30 matches an upper edge of the box 80, and a lower surface of the connection panel 30 may have a folded edge around it, so that the connection panel 30 can be covered on a top of the box 80. A bottom through hole of the box 80 matches a position of the connecting hole on the LED light panel 40, and the box 80 is fixedly connected to the LED light panel 40 through screws or bolts.

A bottom end of the threaded lamp head 10 of this new type is connected to the top end of the structural column 20, and a bottom end of the structural column 20 is detachably connected to the top of the connection panel 30. The center of the connection panel 30 is provided with an opening 301, and its bottom is connected to the rear of the LED light panel 40. One side where the LED light beads of the LED light panel 40 are located is facing downwards. The power end of the driver 50 is electrically connected to the conductive end of the threaded lamp head 10 through a conductive wire, and the driver 50 is electrically connected to the LED light panel 40, achieving the electrical connection between the lamp and the threaded lamp head as well as the basic lighting function of the lamp. Through the detachable connection between the connection panel 30 and the structural column 20, it is convenient to separate the LED light panel 40 separately for replacement or maintenance, reducing costs.

And the present disclosure provides a lighting fixture, including an LED light panel 40 and a lamp head structure, where the lamp head structure is any one of the lamp head structures described in the embodiments of the present disclosure. The LED light panel serves as the electrical unit of the lamp head structure and is electrically connected to the driver of the lamp head structure. The connection panel between the LED light panel and the lamp head structure is detachably connected. This type of LED lighting fixture has smaller packaging during transportation, reducing costs.

In an implementation mode, it further includes a color temperature toggle switch 11, as shown in FIG. 9. The color temperature toggle switch 11 is provided on the structural column or connection panel, and is electrically connected to the driver. The driver is configured to change color temperature of the LED light panel according to a state of the color temperature toggle switch. In an implementation mode, the driver 50 can be provided inside the structural column or the connection panel. By adjusting a position of the color temperature toggle switch, the color temperature of the LED light panel can be changed to achieve the purpose of adjusting the color temperature. It should be noted that a driver circuit of the LED light panel can use existing driver circuits. When provided with the color temperature toggle switch, the driver circuit of the LED light panel can use existing driver circuits with color temperature adjustment. The circuit part is based on existing technology and will not be repeated in the present disclosure.

It should be noted that although the above embodiments have been described in this specification, it does not limit the protection scope of the present disclosure. Therefore, based on the innovative concept of the present disclosure, any changes and modifications made to the embodiments described in this specification, or equivalent structural or process transformations made using the content of the present disclosure specification and drawings, directly or indirectly applying the above technical solutions to other related technical fields, are all included in a protection scope of the present disclosure.

What is claimed is:

1. A detachable lamp head structure, comprising: a threaded lamp head, a structural column, a connection panel, an electrical unit, and a driver;
a bottom end of the threaded lamp head is connected to a top end of the structural column, and a bottom end of the structural column is detachably connected to a top of the connection panel, a center of the connection panel is provided with an opening, and its bottom is connected to a rear of the electrical unit;
the driver is provided inside the structural column, the connection panel, or outside the structural column and the connection panel;
a power end of the driver is electrically connected to a conductive end of the threaded lamp head through a conductive wire, and the driver is electrically connected to the electrical unit.

2. The detachable lamp head structure according to claim 1, wherein a detachable connection method between the connection panel and the structural column comprises threaded rotation connection, snap fit connection, slider groove connection, and pin connection; and/or
the threaded lamp head comprises a plurality screw heads with different specifications.

3. The detachable lamp head structure according to claim 1, wherein a sleeve ring is provided on the connection panel, and the sleeve ring is configured to mutually sleeve connect with a bottom end of the structural column.

4. The detachable lamp head structure according to claim 3, further comprising a limit convex ring;
wherein the limit convex ring is provided on an outer side of a bottom of the structural column, and there is a distance between a bottom of the limit convex ring and a bottom end of the structural column, or the limit convex ring is provided on a lower edge of an inner side of the sleeve ring.

5. The detachable lamp head structure according to claim 4, wherein the structural column is a telescopic structure, the telescopic structure comprises a plurality of telescopic sleeves, adjacent two telescopic sleeves are interlocked and an end of the telescopic sleeves is provided with a fixing component, and the fixing component is configured to limit a maximum distance of mutual sliding between the two telescopic sleeves.

6. The detachable lamp head structure according to claim 1, wherein it further comprises conductive components, and the conductive components are respectively provided on the connection panel and the structural column;
when the connection panel is connected to the structural column, the conductive components of the connection panel are electrically connected to the conductive components of the structural column.

7. The detachable lamp head structure according to claim 1, wherein it further comprises a box, wherein the box is provided between the structural column and the connection panel, and the driver is provided inside the box.

8. The detachable lamp head structure according to claim 7, wherein an upper side of the box is open and covered by connecting with the connection panel, and a bottom of the box is provided with a plurality of through holes.

9. A lighting fixture, comprising: an LED light panel and a lamp head structure,
wherein the lamp head structure is the lamp head structure according to claim 1,
wherein the LED light panel serves as the electrical unit of the lamp head structure and is electrically connected to the driver of the lamp head structure, and the LED light panel is detachably connected to connection panel of the lamp head structure.

10. A lighting fixture according to claim 9, wherein it further comprises a color temperature toggle switch, and the color temperature toggle switch is provided on the structural column or connection panel of the lamp head structure, and is electrically connected to the driver;
wherein the driver is configured to change color temperature of the LED light panel according to a state of the color temperature toggle switch.
